(19) United States
(12) Patent Application Publication
(10) Pub. No.: US 2011/0080807 A1
(43) Pub. Date: Apr. 7, 2011

(54) METHOD FOR COLLISION RISK MITIGATION USING INTELLIGENT NON-INVASIVE ULTRASONIC SENSORS FOR DIRECTIONAL DRILLING

(75) Inventors: Geir Instanes, Bergen (NO); Hans Wagner, Houston, TX (US); Jim Boecker, Houston, TX (US); David Caldwell, Houston, TX (US); Mads Toppe, Bergen (NO)

(73) Assignee: CLAMPON, INC., Houston, TX (US)

(21) Appl. No.: 12/572,901

(22) Filed: Oct. 2, 2009

(51) Int. Cl. G01V 1/00

(52) U.S. Cl. 367/41

(57) ABSTRACT

A method of directional drilling which comprises an intelligent non-invasive ultrasonic sensors that can detect the approaching of an existing well and then can stop and redirect the directional drilling to prevent collisions with preexisting wells.

### FIELD

The present embodiments generally relate to a method for using intelligent non-invasive ultrasonic sensors for directional drilling with existing wells that for sensing when the directional drilling is approaching dangerously close to the existing well, which can then stop and redirect the directional drilling to prevent collisions with preexisting wells.

### BACKGROUND

A need exists for a method of directional drilling when can detect, while drilling, the approaching of an existing well.

A further need exists for a method of directional drilling which comprises a sensor that can detect the approaching of an existing well and then can stop and redirect the directional drilling to prevent collisions with the existing well.

The present embodiments meet these needs.

### BRIEF DESCRIPTION OF THE DRAWINGS

The detailed description will be better understood in conjunction with the accompanying drawings as follows:

FIG. 1 depicts a diagram of the components of a system useable with the present method.

FIG. 2 shows an embodiment of frequency signatures and an alarm displayed on a control display

FIG. 3 shows an embodiment of a intelligent non-invasive ultrasonic sensor

FIG. 4 shows an embodiment of a flow chart of the steps of the method

The present embodiments are detailed below with reference to the listed Figures.

### DETAILED DESCRIPTION OF THE EMBODIMENTS

Before explaining the present method in detail, it is to be understood that the method is not limited to the particular embodiments and that it can be practiced or carried out in various ways.

The present embodiments relate to a method for using at least one intelligent non-invasive ultrasonic sensors for directional drilling with existing wells that for sensing when the directional drilling is approaching dangerously close to the existing well, which then stops and redirects the directional drilling to prevent collisions with at least one of the existing wells.

The method for using intelligent non-invasive ultrasonic sensors for directional drilling with existing wells, comprises installing an intelligent non-invasive ultrasonic sensor on a casing of at least one existing well.

The method can further comprise installing a second intelligent non-invasive ultrasonic sensor on the second well.

Installing the intelligent non-invasive ultrasonic sensor can be done by clamping with a clamp or fixture.

In an embodiment, the intelligent non invasive ultrasonic sensor can be adapted to detect low and high frequency signatures from the directional drilling as the directional drilling approaches the casing. The ultrasonic sensor can be used with low, high, or spectrum frequencies. In one or more embodiments, the sensor can be a passive acoustic ultrasonic sensor. The intelligent non-invasive ultrasonic sensor can be fitted with a sensing element, which can be a piezo-electric sensor, an accelerometer sensors, or combinations of thereof for signature pickup.

The sensing element, such as a piezo-electric sensor or an accelerometer can be used in the production and detection of sound, or sense orientation, vibration and shock, which can be helpful in detecting if the directional drilling is coming close to an existing well or if there are chances of a possible collision with an additional well.

A power and communication unit is connected to the intelligent non-invasive ultrasonic sensor for providing power to the sensor and for collecting the detected frequency signatures from the sensor and transmitting the detected frequency signatures.

The power and communication unit can also be connected to a control processor with a control data storage and control computer instructions. The control computer instructions can be located in the control data storage for analyzing the frequency signatures and computing changes in the frequency signatures.

The method then involves cutting a window in a second well using directional drilling and establishing a first baseline frequency signature with a first baseline amplitude, without drilling into the second well.

The frequency signatures are then detected as the directional drilling approaches the existing well, pipe wall will transmit the source energy, such as frequency and vibration from the drilling bit, with the intelligent non-invasive ultrasonic sensor and then the detected frequency signatures are transmitted to the power and communication unit to the control processor to be computed.

The changes in detected frequency signatures are then computed with the control processor to determine when the first baseline frequency signature increases past a proximity frequency, wherein the proximity frequency can then indicate that the directional drilling is approaching dangerously close to the existing well.

If the directional drilling is detected as being dangerously close to an existing well, the method then stops and redirects the directional drilling to prevent collisions with the existing wells.

In an embodiment, the intelligent non-invasive ultrasonic sensor comprises a sensor processor with sensor data storage, such as a flash memory. The sensor data storage can further comprise sensor computer instructions, which can instruct the sensor data storage to transmit the sensed data to the control processor.

The control processor can be connected with a communication cable to the intelligent non-invasive ultrasonic sensor.

The control processor can provide an alarm to a control display associated with the control processor. The alarm can be local, an email, a phone call, a page, an instant message, a text message, or combinations thereof.

In an embodiment, the alarm can be transmitted to a network with at least one client device remote to the directional drilling for monitoring and controlling a plurality of directional drilling activities simultaneously.

In another embodiment, the alarm can be transmitted through two gateway protocols simultaneously to at least two client devices simultaneously to prevent collision very quickly and notify the user if the directional drilling is coming close to a second preexisting well.

In an embodiment, the alarm can be transmitted to at least one user viewing the control display to immediately prevent further directional drilling in the direction of the preexisting well.

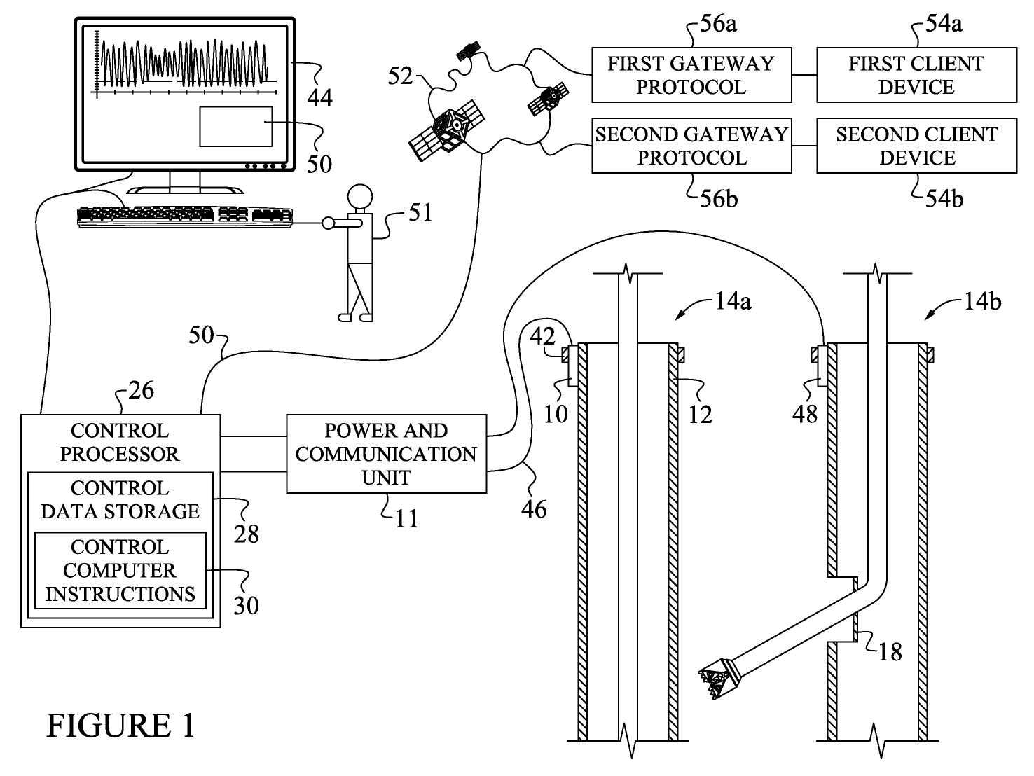

Turning now to the Figures, FIG. 1 depicts a diagram of the components of a system useable with the present method.

An intelligent non-invasive ultrasonic sensor 10 is shown on a casing 12 of an existing well 14a. The existing well 14a can be produce simultaneously with the sensing or directional drilling operations. In one or more embodiments, each casing or tubing for a plurality of adjacent wells, for example, when directional drilling is performed in a cluster array, can have an intelligent non-invasive ultrasonic sensor installed thereon. For example, in an array of 12 wells the casing of each well can have an intelligent non-invasive ultrasonic sensor installed thereon.

It can be contemplated in an embodiment, that the intelligent non-invasive ultrasonic sensor 10 can be connected to the casing 12 of an existing well with a clamp 42. In one or more embodiments, the casing 12 can transmit the acoustic energy to the surface. The intelligent non-invasive ultrasonic sensor 10 can have mechanical contact to casing 12 to allow acoustic coupling between the intelligent non-invasive ultrasonic sensor 10 and casing 12. For example, during drilling a rotating drill bit generates energy and frequencies that the nearby casing 12 will pick up, and the casing 12 will act as a conductor for frequency transmission of energy to surface. The closer a drill bit is to a casing 12, the larger the energy and amplitude level will be. A collision between drill bit and casing 12 will generate large energy levels.

The clamp can be removable and reusable and can further comprise a band of rolled steel plate, which can be 316 grade steel, about 0.5 inch to about 2 inches in width, the length can depend on the size of the casing.

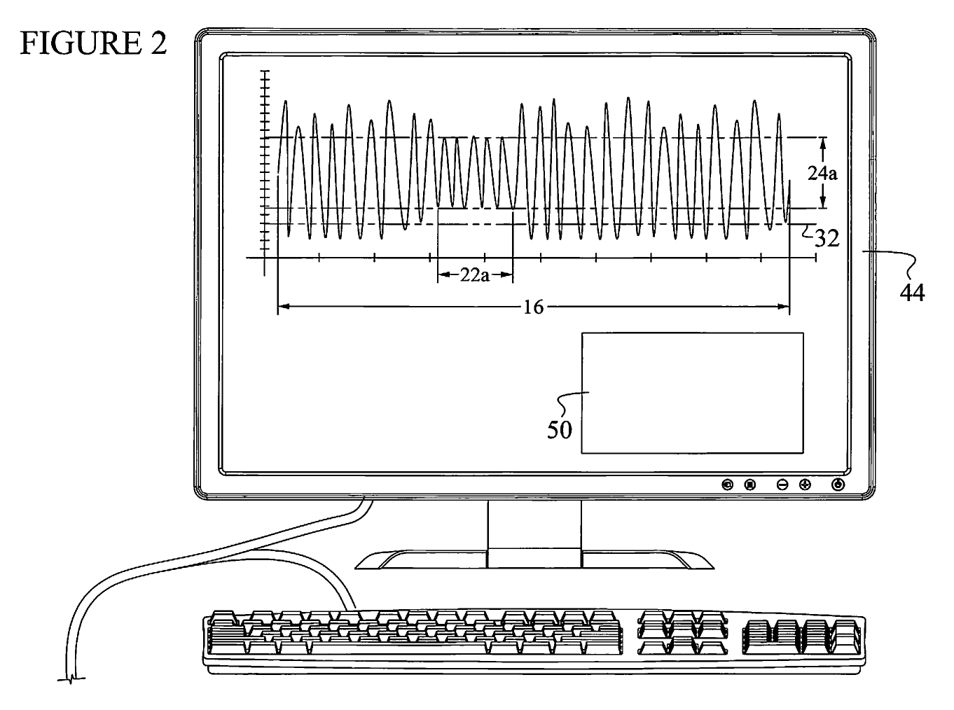

The intelligent non invasive ultrasonic sensor 10 can be adapted to detect frequency signatures 16, which is shown in detail in FIG. 2, from directional drilling.

A power and communication unit 11 is shown connected to the intelligent non-invasive ultrasonic sensor 10 with a communication cable 46. The power and communication unit 11 can provide power to the intelligent non-invasive ultrasonic sensor 10. The power and communication unit 11 can also collect the detected frequency signatures from the intelligent non-invasive ultrasonic sensor 10 and transmit the detected frequency signatures to a control processor 26.

The control processor 26 is shown connected to the power and communication unit 11. The control processor 26 can have a control data storage 28 with control computer instructions 30 for analyzing the frequency signatures 16, as shown in FIG. 2, and computing changes in the frequency signatures 16.

A window 18 is shown cut into an existing well 14b using directional drilling. When the window 18 is cut into the existing well 14b, a first baseline frequency signature 22a with a first baseline amplitude 24a, shown in FIG. 2, can be established.

A second intelligent non-invasive ultrasonic sensor 48 can be connected to a second existing well 14b. It can be contemplated that an intelligent non-invasive ultrasonic sensor can be connected to any existing well to help prevent any collisions with any of the existing wells in the area.

The control processor can provide an alarm 50 to at least one user 51 viewing a control display 44 to immediately prevent further directional drilling in the direction of the preexisting well.

The alarm 50 can also be transmitted, through a network 52 with at least on gateway protocol 56a and 56b, to at least one client device 54a, 54b for monitoring and controlling a plurality of directional drilling activities simultaneously.

While two client devices are show, it can be contemplated that the alarm can be transmitted to more than two client devices.

Similarly, while two existing wells are shown in this embodiment, it can be contemplated that more than two wells can be monitored, to prevent collision, with this method.

FIG. 2 shows an embodiment of frequency signatures and an alarm displayed on a control display.

As stated above, when the window 18 is cut into the existing well 14, a first baseline frequency signature 22a with a first baseline amplitude 24a can be established in the frequency signatures 16.

A proximity frequency 32 can also be established in the frequency signatures 16 when the window 18 is cut into the second existing well 14b.

As directional drilling continues, the detected frequency signatures 16 can be monitored by at least one user 51 viewing a control display 44.

The control processor 26 can compute changes in the detected frequency signatures 16 to determine when the detected frequency signatures 16 increase past the proximity frequency 32 and near the first baseline frequency signature 22a, wherein the proximity frequency indicates that the directional drilling is approaching dangerously close to the existing well.

When the detected frequency signatures 16 increase past the proximity frequency 32, and near the first baseline frequency signature 22a, the control processor 26 can produce the alarm 50 to be displayed on the control display 44.

The user 51 viewing a control display 44 can stop and redirect the directional drilling to prevent collisions with at least one of the existing wells.

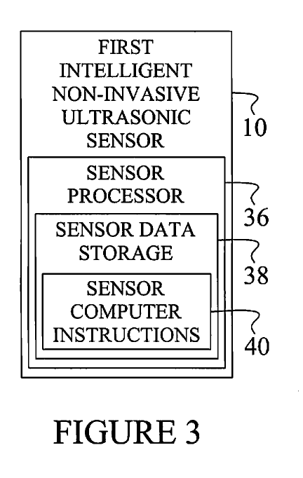

FIG. 3 shows an embodiment of an intelligent non-invasive ultrasonic sensor.

The intelligent non-invasive ultrasonic sensor 10 can have a sensor processor 36 with sensor data storage 38, such as a flash memory.

The sensor data storage 38 can have sensor computer instructions 40 for transmitting sensed data to the control processor.

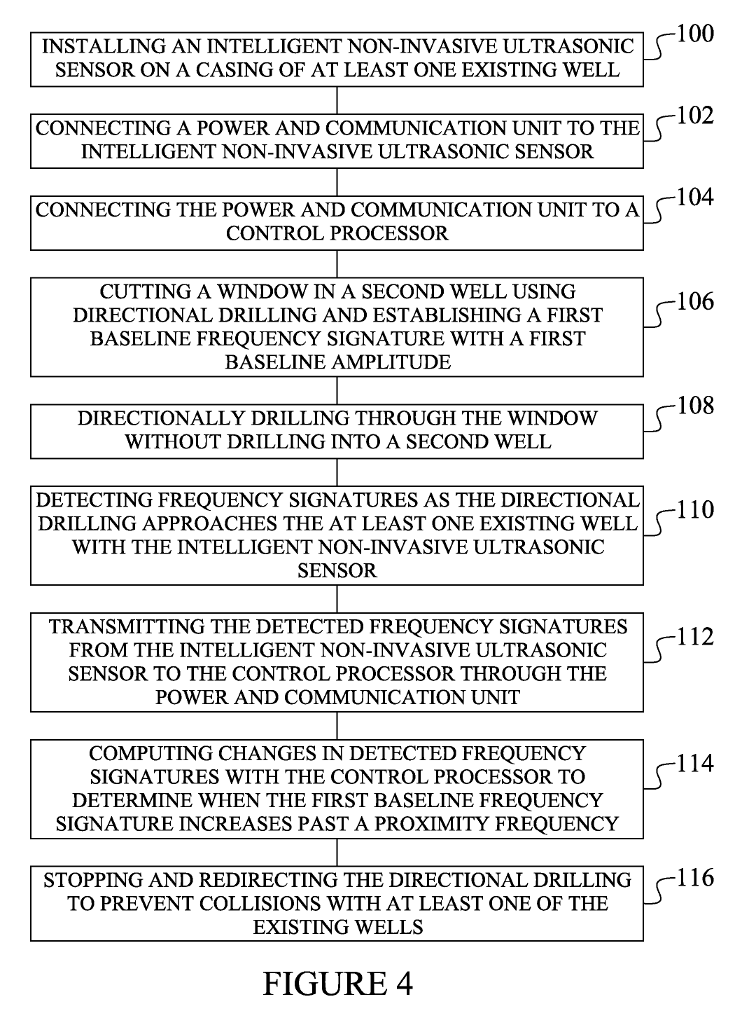

FIG. 4 shows an embodiment of a flow chart of the steps of the method.

The method includes the Step 100 of installing an intelligent non-invasive ultrasonic sensor on a casing of at least one existing well.

The intelligent non invasive ultrasonic sensor can be adapted to detect frequency signatures from directional drilling as the directional drilling approaches the casing.

The method includes Step 102 of connecting a power and communication unit to the intelligent non-invasive ultrasonic sensor.

The power and communication unit can provide power to the intelligent non-invasive ultrasonic sensor while collecting and transmitting the detected frequency signatures from the intelligent non-invasive ultrasonic sensor.

The method includes Step 104 of connecting the power and communication unit to a control processor.

The control processor can have control data storage and control computer instructions in the control data storage for analyzing and computing changes in the frequency signatures.

The method includes Step 106 of cutting a window in a second well using directional drilling and establishing a first baseline frequency signature with a first baseline amplitude.

The method includes Step 108 of directionally drilling through the window without drilling into a second well.

The method includes Step 110 of detecting frequency signatures as the directional drilling approaches the at least one existing well with the intelligent non-invasive ultrasonic sensor.

The method includes Step 112 of transmitting the detected frequency signatures from the intelligent non-invasive ultrasonic sensor to the control processor through the power and communication unit.

The method includes Step 114 of computing changes in detected frequency signatures with the control processor to determine when the first baseline frequency signature increases past a proximity frequency.

The proximity frequency can indicate that the directional drilling is approaching dangerously close to an existing well.

The method includes Step 116 of stopping and redirecting the directional drilling to prevent collisions with at least one of the existing wells.

While these embodiments have been described with emphasis on the embodiments, it should be understood that within the scope of the appended claims, the embodiments might be practiced other than as specifically described herein.

What is claimed is:

1. A method for using intelligent non-invasive ultrasonic sensors for detection of potential collision to nearby well, casing, during directional drilling with existing wells, comprising:
a. installing an intelligent non-invasive ultrasonic sensor on a casing of at least one existing well wherein the intelligent non-invasive ultrasonic sensor is adapted to detect low and high frequency signatures from the directional drilling as the directional drilling approaches the casing;
b. connecting a power and communication unit to the intelligent non-invasive ultrasonic sensor for providing power to the intelligent non-invasive ultrasonic sensor and for collecting the detected frequency signatures from the intelligent non-invasive ultrasonic sensor and transmitting the detected frequency signatures;
c. connecting the power and communication unit to a control processor with a control data storage and control computer instructions in the control data storage for analyzing the frequency signatures and computing changes in the frequency signatures;
d. cutting a window in a second well using directional drilling and establishing a first baseline frequency signature with a first baseline amplitude;
e. directionally drilling through the window without drilling into a second well;
f. detecting frequency signatures as the directional drilling approaches the at least one existing well with the intelligent non-invasive ultrasonic sensor;
g. transmitting the detected frequency signatures from the intelligent non-invasive ultrasonic sensor to the power and communication unit to the control processor;
h. computing changes in detected frequency signatures with the control processor to determine when the first baseline frequency signature increases past a proximity frequency, wherein the proximity frequency indicates that the directional drilling is approaching dangerously close to the existing well; and
i. stopping and redirecting the directional drilling to prevent collisions with at least one of the existing wells.

2. The method of claim 1, wherein the intelligent non-invasive ultrasonic sensor with mechanical contact to casing comprises a sensor processor with sensing elements, piezo-electric, accelerometer or combination thereof, with sensor data storage with sensor computer instructions in the sensor data storage for transmitting sensed data to the control processor.

3. The method of claim 1, wherein the installing of the intelligent non-invasive ultrasonic sensor is by clamping with a clamp.

4. The method of claim 3, wherein the clamp comprises a band of rolled steel plate or a steel clamp.

5. The method of claim 3, wherein the clamp is removable and reusable.

6. The method of claim 1, wherein the control processor provides an alarm to a control display associated with the control processor.

7. The method of claim 6, wherein the alarm is transmitted to at least one user viewing the control display to immediately prevent further directional drilling in the direction of the preexisting well.

8. The method of claim 7, wherein the alarm is transmitted to a network with at least one client device remote to the directional drilling for monitoring and controlling a plurality of directional drilling activities simultaneously.

9. The method of claim 6, wherein the alarm is local, an email, a phone call, a page, an instant message, a text message, or combinations thereof.

10. The method of claim 6, wherein the alarm is provided through two gateway protocols simultaneously to at least two client devices simultaneously to prevent collision very quickly.

11. The method of claim 1, further comprising installing a second intelligent non-invasive ultrasonic sensor on the second well.

12. The method of claim 1, wherein the intelligent non-invasive ultrasonic sensor is connected with a communication cable to the control processor.

13. The method of claim 1, further comprising installing the intelligent non-invasive ultrasonic sensor on adjacent wells when directional drilling is performed in a cluster array.
